(19) United States
(12) Patent Application Publication
(10) Pub. No.: US 2009/0174723 A1
(43) Pub. Date: Jul. 9, 2009

(54) COLOR DISPLAY

(75) Inventors: Adrianus Johannes Stephanes Maria De Vaan, Eindhoven (NL); Paulus Cornelis Renier Teeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,401

(22) PCT Filed: May 19, 2005
(86) PCT No.: PCT/IB05/51629

§ 371 Date: Nov. 20, 2006

(30) Foreign Application Priority Data
May 24, 2004 (EP) 04102251.8

(51) Int. Cl. G09G 5/02; G09G 3/36

(52) U.S. Cl. 345/589; 345/88; 345/690

(57) ABSTRACT

Power is saved in a color display system (200) by sacrificing color rendering capability in favor of brightness capability. The system (200) comprises a plurality of light emitters (202,204,206). The emitters are fed with a respective initial electric power input which adds up to a first total electric power input, whereby each light emitter provides an initial first color intensity, a second color intensity and a third color intensity, respectively, which, in combination, are perceivable to the human eye as an initial total brightness. Power input is then reduced to a second total power input by feeding each light emitter with a respective second electric power input, whereby the second total power input that is less than said first total power input is obtained.

The invention relates to a color display system and a method of operating such a system.

Consumer demand in the field of electronic devices such as portable computers, mobile telephones, PDAs and digital cameras, now imposes strict requirements on the color displays of these devices to be able to present bright and colorful images as well as less colorful textual information.

Moreover, there is a demand for further improvements in portability of such devices, which involves requirements regarding compact and low-weight designs. However, requirements on low weight often conflict with requirements on battery capacity, resulting in stricter energy consumption requirements on the devices so as to maintain long battery operating times.

Present-day display systems, e.g. color LCD panels, make use of fluorescent light tubes to illuminate the display with a full visible wavelength spectrum. Color information is achieved by integrating absorption-type color filters in the display panel to absorb the wrong colors for groups of pixels, such that a red, green and blue image can be obtained by these individual groups of pixels.

In order to improve battery operating lifetime of these types of devices, the backlight system is typically configured in such a way that it is possible to set it to a lower power mode while the device is battery-operated and to a high power mode when the product is connected to the mains.

Hence, in current techniques utilizing an illumination method using fluorescent tubes, the only way in which different power settings of the backlight system are possible is by providing less power to the fluorescent tubes, resulting in the problem of a low brightness of the display.

U.S. Pat. No. 6,262,710 describes a power save for polymer displays. Calculations relating to the effects of different color spaces are used to find solutions leading to a low power consumption, while maintaining the color rendering capability of the device. Such calculations are complex and hence require an intricate design of the control circuitry needed to operate the display.

It is therefore an object of the invention to overcome the drawbacks relating to power consumption of prior-art color display systems.

The object is achieved by a color display system and a method of operating such a system comprising at least a first color light emitter, a second color light emitter and a third color light emitter. The emitters are fed with an initial electric power input denoted P_{C1,0}, P_{C2,0} and P_{C3,0}, respectively, which add up to a first total electric power input, whereby each light emitter provides an initial first color intensity, a second color intensity and a third color intensity, respectively, which, in combination, are perceivable to the human eye as an initial total brightness. Power input is then reduced to a second total power input by feeding each light emitter with a second electric power input denoted P_{C1,1}, P_{C2,1} and P_{C3,1}, respectively, whereby the second total power input that is less than said first total power input is obtained, and wherein the power ratios are P_{C3,1/}P_{C3,0<}P_{C2,0/}P_{C2,1} and P_{C1,1/}P_{C1,0<}P_{C2,0/}P_{C2,1}.

After the reduction of the power input, the combined intensities of the light emitters are preferably perceivable to the human eye as a total brightness which is substantially the same as the initial total brightness prior to the reduction of the power input.

It is also preferred that power input to the second color light emitter is increased, so that it generates a second color intensity, which combines with the first color intensity and the third color intensity and is perceivable to the human eye substantially as said first total brightness.

In a preferred embodiment, the power input to each first color light emitter and third color light emitter is substantially zero.

The system may also comprise at least a fourth color light emitter, with power being input to said fourth color light emitter, whereby the fourth color light emitter generates a fourth color intensity, which combines with the second color intensity and is perceivable to the human eye substantially as said first total brightness.

In a preferred embodiment, the power inputs relate to each other as P_{C3,1/}P_{C3,0<}0.7*P_{C2,0/}P_{C2,1} and P_{C1,1/}P_{C1,0<}0.7*P_{C2,0/}P_{C2,1}.

In another preferred embodiment, the power inputs relate to each other as P_{C3,1/}P_{C3,0<}0.5*P_{C2,0/}P_{C2,1} and P_{C1,1/}P_{C1,0<}0.5*P_{C2,0/}P_{C2,1}.

The first, the second and the third color are preferably red, green and blue, respectively, and the fourth color is any one of the group comprising cyan, yellow and amber.

By using individual light emitters for generating the red, green and blue light, such as e.g. a LED-backlit LCD display, the color balance can be optimized for individual modes of use, i.e. adapted to different requirements regarding color rendering capability, so that power usage, and hence battery-operating lifetime, can be improved. Since the human eye has its greatest sensitivity in the green part of the spectrum, it is possible to maintain the same brightness of the display by moving the white color towards green and simultaneously reducing the power fed to the light emitters.

In a typical color display system, the green, red and blue light contribute 60%, 30% and 10% to the perceived brightness when generating a full white image. When the display system according to the invention is incorporated in a PC, the red and blue light emitters, e.g. LEDs, can therefore be switched off completely while the green light emitters are boosted by 66% in circumstances in which e.g. only word-editing is required. As a result, the perceived brightness is unchanged while simultaneously the power consumption of the display system is reduced by 50%. The drawback in such a case is that only green pictures can be observed and that all characters appear in green as well.

Although adding a fourth light emitter means added complexity, cyan or amber light emitters in the form of LEDs are very efficient and contribute to the general advantage of power saving while a number of attractive colors can still be achieved and give design freedom to develop a product appealing to the end user. Moreover, a cyan LED has a longer lifetime than e.g. a blue LED. Any extra complexity may thus be compensated by a longer lifetime of the device.

The method is particularly useful in products in which the red, green and blue light are generated by individual light-emissive elements, such as LED-backlit LCD products, Poly-LED displays, laser-based displays, etc.

These and other aspects of the invention are apparent from and will be elucidated with reference to the embodiments described hereinafter.

In the drawings,

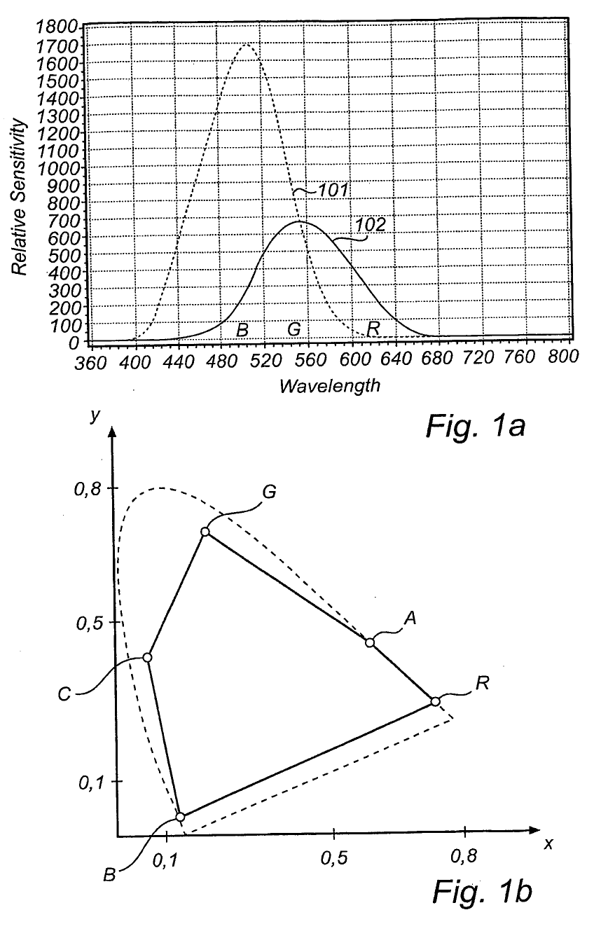

FIG. 1a is a diagram showing a human eye's relative sensitivity to light of different wavelengths.

FIG. 1b is a CIE 1931 chromaticity diagram.

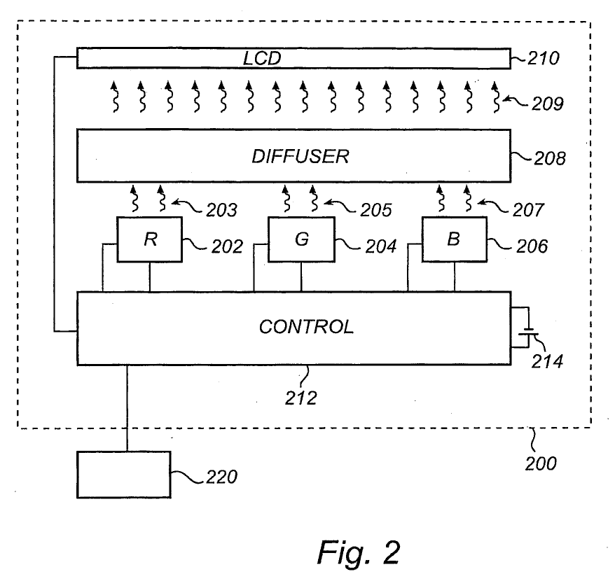

FIG. 2 is a block diagram of a system in accordance with a first embodiment of the invention.

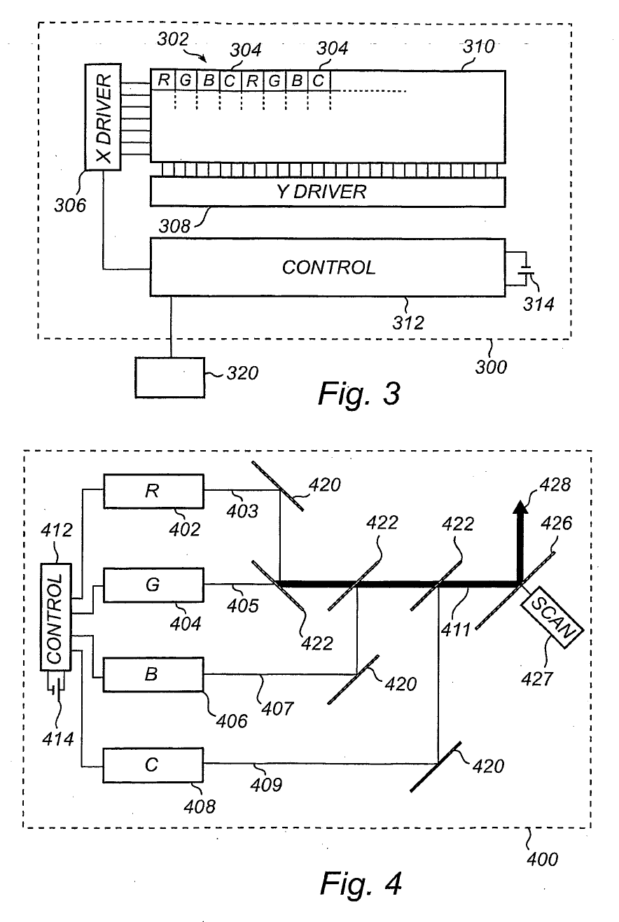

FIG. 3 is a block diagram of a system in accordance with a second embodiment of the invention.

FIG. 4 is a block diagram of a system in accordance with a third embodiment of the invention.

The invention will now be described with reference to examples of light emitters having properties in the RGB color space. Qualitative examples of applications in backlit LCDs, Poly-LEDs and scanning laser systems will be presented, followed by a description of quantitative experiments and simulations.

The human eye is sensitive to light of different wavelengths as shown in the diagram of FIG. 1a. Relative sensitivity is plotted as a function of the wavelength in nanometers. The dotted curve 101 shows the relative sensitivity of the rods, i.e. the elements of the eye that are sensitive essentially only in terms of brightness. The solid curve 102 shows the relative sensitivity of the cones, i.e. the elements of the eye that are sensitive to different colors. The colors red (R), green (G) and blue (B) are also indicated in FIG. 1a. In the following descriptions of preferred embodiments, reference will be made to light in a spectrum perceivable to the human eye. Such a spectrum ranges from about 400 nanometers to about 700 nanometers.

FIG. 1b shows the well-known CIE 1931 chromaticity diagram, illustrating the loci of the Red R, Green G, Blue B, Cyan C and Amber A colors that define a color gamut used in the experiments and simulations to be discussed below.

FIG. 2 shows a color display system 200 according to the invention in the form of a so-called backlight system for an LCD. The system 200 may form part of e.g. a portable computer, a PDA, a mobile telephone, a digital camera, or any other type of electronic device that requires a power-efficient display system. Although it is not shown in detail, such an electronic device, denoted by reference numeral 220 in FIG. 2, has all the functionalities that are required for its normal operation, such as the supply of data to be displayed by the color display system 200 as well as any other signal needed for operating the color display system 200. It will be evident to those skilled in the art that, for the sake of clarity, the functionality of the electronic device 220 will not be described in detail.

The color display system 200 comprises control circuitry 212, which controls the power input to a number of light emitters in the form of light-emitting diodes (LEDs): a red LED 202, a green LED 204 and a blue LED 206. The power source for the LEDs is schematically illustrated by a battery 214 connected in the system 200 to the control circuitry 212. The color display system 200 typically comprises a plurality of LEDs, i.e. more than the three LEDs illustrated in FIG. 2.

When controlled by the control circuitry 212, the power input to the LEDs 202, 204 and 206 results in emission of light from each LED, as illustrated in FIG. 2 by red light 203, green light 205 and blue light 207 being emitted into an optical diffuser 208. As will be evident to those skilled in the art, the diffuser creates a “blend” of the light emanating from the light emitters 202, 204 and 206 and emits light, which forms a more or less continuous spectrum of white light 209. The white light 209 is incident on an LCD unit 210, which is controlled to generate a color image by the control circuitry 212 in combination with control signals from the circuitry of the electronic device 220.

In a first mode of operation, the display system 200 is operated in such a way that the light emitters 202, 204 and 206 are provided with an initial red, green and blue emitter power input, respectively. These individual power values add up to a first total power input. By converting the power input into light, each light emitter 202, 204 and 206 initially generates a red, a green and a blue intensity, respectively, which, in combination, i.e. with the “blended” light 209 emanating from the diffuser 208, are perceivable to the human eye as a first total brightness.

In a second mode of operation, the power input is reduced to the red 202 and blue 206 light emitters. A second total power input that is less than the first total power input is thereby obtained, and each light emitter 202, 204 and 206 generates a red, a green and a blue intensity, respectively, which, in combination, are perceivable to the human eye substantially as the first total brightness.

In an alternative embodiment, the system illustrated in FIG. 2 may comprise light emitters in the form of laser lamps, instead of LEDs.

Power to the light emitters is preferably controlled in such a way that the red brightness becomes less than 33% of the green brightness and the blue brightness becomes less than 12% of the green brightness. Alternatively, power to the light emitters is controlled in such a way that the red and the blue brightness become zero.

As will be evident to those skilled in the art, the operation described above is preferably implemented by means of a combination of logic circuitry in the controller 212 and software instructions in the electronic device 220.

FIG. 3 shows a color display system 300 according to the invention in the form of a so-called poly-LED system. The system 300 may form part of e.g. a portable computer, a PDA, a mobile telephone, a digital camera, or any other type of electronic device that requires a power-efficient display system. Although it is not shown in detail, such an electronic device, denoted by reference numeral 320 in FIG. 3, has all the functionalities that are required for its normal operation, such as the supply of data to be displayed by the color display system 300 as well as any other signal needed for operating the color display system 300. It will be evident to those skilled in the art that, for the sake of clarity, the functionality of the electronic device 320 will not be described in detail.

The color display system 300 comprises control circuitry 312, which, by way of X driver circuitry 306 and Y driver circuitry 308, controls the power input to a matrix of light emitters 310 in the form of light-emitting diodes (LEDs) 302. In addition to red, green and blue LEDs, as indicated by R, G and B, respectively, in the matrix 310, cyan LEDs 304 are also present. The power source for the matrix 310 of LEDs is schematically illustrated by a battery 314 connected in the system 300 to the control circuitry 312.

When controlled by the control circuitry 312 and by the circuitry of the device 320 incorporating the display system 320, the power input to the matrix 310 of LEDs results in emission of light from each LED so that a color image is produced on the matrix 310 of LEDs. The image produced will contain colors of a gamut as defined by the characteristics of the LEDs in the matrix 310.

In a first mode of operation, the display system 300 is operated in such a way that the light emitters of the matrix 310 are provided with an initial red, green, blue and cyan emitter power input, respectively. These individual power values add up to a first total power input. By converting the power input into light, each light emitter in the matrix 310 initially generates a red, a green, a blue and a cyan intensity, respectively, which are perceivable to the human eye as a first total brightness.

In a second mode of operation, the power input is reduced to the red and blue light emitters of the matrix 310. A second total power input that is less than the first total power input is thereby obtained, and each light emitter of the matrix 310 generates a red, a green, a blue and a cyan intensity which, in combination, are perceivable to the human eye substantially as the first total brightness.

Power to the light emitters is preferably controlled in such a way that the red brightness becomes less than 33% of the green brightness and the blue brightness becomes less than 12% of the green brightness. Alternatively, power to the light emitters is controlled in such a way that the red and the blue brightness become zero.

As will be evident to those skilled in the art, the operation described above is preferably implemented by means of a combination of logic circuitry in the controller 212 and software instructions in the electronic device 220.

Furthermore, Amber colored LEDs may be used instead of the Cyan LEDs; or a poly-LED display containing 5 colors (e.g. Red, Green, Blue, Cyan, and Amber) may be used.

FIG. 4 shows a color display system 400 according to the invention in the form of a so-called scanning laser system. The system 400 may form part of e.g. a portable image projection system or any other type of electronic device that requires a power-efficient display system. Similarly as in previous embodiments described with reference to FIGS. 2 and 3, the color display system 400 is controlled by such a device.

The color display system 400 comprises control circuitry 412, which controls the power input to light emitters in the form of light-emitting lasers: a red laser 402, a green laser 404, a blue laser 406 and a cyan laser 408. The power source for the lasers 402, 404, 406 and 408 is schematically illustrated by a battery 414 connected in the system 400 to the control circuitry 412.

When controlled by the control circuitry 412 and by the circuitry, the power input to the lasers 402, 404, 406 and 408 results in emission of light from each laser in the form of laser beams 403, 405, 407 and 409, respectively. The laser beams 403, 405, 407 and 409 travel via a system of folding mirrors 420 and dichroic mirrors 422 to form a composite beam 411, which is reflected in a scan mirror 426, controlled by a scan unit 427, to form an image as indicated by reference numeral 428. As the scan unit 427 is well known to those skilled in the art, its operation will not be described.

The image 427 produced will contain colors of a gamut as defined by the characteristics of the lasers 402, 404, 406 and 408.

In a first mode of operation, the display system 400 is operated in such a way that the light emitters 402, 404, 406 and 408 are provided with an initial red, green, blue and cyan emitter power input, respectively. These individual power values add up to a first total power input. By converting the power input into light, each light emitter 402, 404, 406 and 408 initially generates a red, a green, a blue and a cyan intensity, respectively, which are perceivable to the human eye as a first total brightness.

In a second mode of operation, the power input is reduced to the red and blue light emitters 402 and 406. A second total power input that is less than the first total power input is thereby obtained, and each light emitter generates a red, a green, a blue and a cyan intensity, respectively, which, in combination, are perceivable to the human eye substantially as the first total brightness.

Power to the light emitters 402, 404, 406 and 408 is preferably controlled in such a way that the red brightness becomes less than 33% of the green brightness and the blue brightness becomes less than 12% of the green brightness. Alternatively, power to the light emitters is controlled in such a way that the red and the blue brightness become zero.

Furthermore, a Yellow laser could be used instead of the Cyan one; or a scanning laser projection system containing 5 colors (e.g. Red, Green, Blue, Cyan, and Yellow) could be used.

Experiments using conventional solid-state LEDs yielded the following results. Table 1a shows pertinent information regarding the characteristics of the LEDs.

TABLE 1a

| | | | Performance |
|---|---|---|---|
| LED color | x | y | (Lumen/Watt) |
| Red | 0.700 | 0.299 | 44 |
| Green | 0.207 | 0.709 | 30 |
| Blue | 0.152 | 0.026 | 10 |

In Table 1a, the x and y values refer to the location of the respective color in the CIE-1931 chromaticity diagram illustrated schematically in FIG. 1b.

Results of experiments, using the LEDs of Table 1a, are presented in Table 1b.

TABLE 1b

| | Initial power | Reduced power |
|---|---|---|
| LED color | (Watt) | (Watt) |
| Red | 0.22 | 0.93 |
| Green | 1.00 | 0.0 |
| Blue | 0.13 | 0.0 |
| Total power: | 1.35 | 0.93 |
| Total flux (Lumen): | 41 | 41 |
| x color: | 0.313 | 0.700 |
| y color: | 0.329 | 0.299 |

As can be seen from the results in Table 1b, a ratio of 69% (i.e. 0.93/1.35) between the total reduced power and the initial power is obtained after reducing the power input to the green and blue LEDs and increasing the power to the red LED, while retaining a total output of 41 Lumen of the combined light from the LEDs. Table 1b also shows the x and y points in the CIE chromaticity diagram, FIG. 1b, for the initial combination of LED output and the output after power reduction. There is a shift from a point (x,y)=(0.313,0.329) being close to the center (i.e. white) part of the diagram to the point (x,y)=(0.700,0.299) being closer to the red part of the diagram.

Simulations using theoretical performance values for LEDs will now be presented in Tables 2a and 2b. It is assumed that LED efficacy will improve in such a way that the LED data used for the simulations will shortly be state of the art. Discussions relating to the evolution of LED efficacy can be found in Nordhaus, W. D. in “The economics of new goods”, Breshnahan, T. F. et al., eds., pp. 29-70, The University of Chicago Press, 1997, as well as in Bergh, A. et al., “SSL-LED Roadmap 2002”, Physics Today 54, pp 42-47, December 2001.

Table 2a is similar to Table 1a and shows data for an amber color LCD and a cyan color LCD as well.

TABLE 2a

| | | | Performance |
|---|---|---|---|
| LED color | x | y | (Lumen/Watt) |
| Red | 0.700 | 0.299 | 50 |
| Green | 0.207 | 0.709 | 170 |
| Blue | 0.152 | 0.026 | 10 |
| Amber | 0.563 | 0.435 | 120 |
| Cyan | 0.084 | 0.413 | 50 |

Table 2b shows simulation results, using the LEDs of Table 2a. Note that the power ratios and the flux ratios (denoted “Power %” and “Flux %”, respectively) are also presented in the Table, illustrating that it is possible to obtain a power ratio ranging from 39% to 52% while maintaining a substantial flux.

It is to be noted that the x and y points in the chromaticity diagram for the combined light in the different simulations tend towards the green part of the diagram.

The actual designed product may use the invention in a various number of ways. For example, in a product incorporating an electronic photo/video recognition circuit, the white point setting of the display (and as such the power drive to the individual colored light sources) is automatically adjusted to the displayed image content.

The actual selected color in a power-save mode can be selected to obtain a visually appealing product (a product having appealing display colors in relation to the colors of the mechanical housing) instead of the most efficient color (being the color of the light source having the highest luminous efficacy).

TABLE 2b

| | Initial | Reduced | Reduced | Reduced |
|---|---|---|---|---|
| LED color | power (W) | power(W) | power(W) | power(W) |
| Red | 1.00 | 0.00 | 0.00 | 0.00 |
| Green | 0.90 | 1.23 | 0.70 | 1.00 |
| Blue | 0.68 | 0.00 | 0.00 | 0.00 |
| Amber | 0.00 | 0.00 | 0.30 | 0.00 |
| Cyan | 0.00 | 0.00 | 0.30 | 0.00 |
| Total power: | 2.58 | 1.23 | 1.30 | 1.00 |
| Total flux: | 210 | 209 | 170 | 170 |
| x color: | 0.313 | 0.207 | 0.294 | 0.207 |
| y color: | 0.325 | 0.709 | 0.592 | 709 |
| | Flux %: | 1.00 | 0.81 | 0.81 |
| | Power %: | 0.48 | 0.50 | 0.39 |
| Red | 1.00 | 0.33 | 0.33 | 0.15 |
| Green | 0.90 | 0.90 | 0.74 | 1.00 |
| Blue | 0.68 | 0.23 | 0.23 | 0.15 |
| Amber | 0.0 | 0.00 | 0.00 | 0.00 |
| Cyan | 0.0 | 0.00 | 0.00 | 0.00 |
| Total power: | 2.58 | 1.46 | 1.30 | 1.30 |
| Total flux (L): | 210 | 172 | 145 | 179 |
| x color: | 0.313 | 0.269 | 0.277 | 0.236 |
| y color: | 0.325 | 0.478 | 0.450 | 0.555 |
| | Flux %: | 0.82 | 0.69 | 0.85 |
| | Power %: | 0.57 | 0.50 | 0.50 |

| | Initial | Reduced | Reduced |
|---|---|---|---|
| LED color | power (W) | power(W) | power(W) |
| Red | 1.00 | 0.00 | 0.15 |
| Green | 0.90 | 1.00 | 0.90 |
| Blue | 0.68 | 0.25 | 0.10 |
| Amber | 0.0 | 0.00 | 0.00 |
| Cyan | 0.0 | 0.00 | 0.20 |
| Total power: | 2.58 | 1.25 | 1.35 |
| Total flux (L): | 210 | 173 | 172 |
| x color: | 0.313 | 0.191 | 0.231 |
| y color: | 0.325 | 0.514 | 0.565 |
| | Flux %: | 0.82 | 0.82 |
| | Power %: | 0.48 | 0.52 |

In summary, power is saved in a color display system by sacrificing color rendering capability in favor of brightness capability. The system comprises a plurality of light emitters. The emitters are fed with a respective initial electric power input which adds up to a first total electric power input, whereby each light emitter provides an initial first color intensity, a second color intensity and a third color intensity, respectively, which, in combination, are perceivable to the human eye as an initial total brightness. Power input is then reduced to a second total power input by feeding each light emitter with a respective second electric power input, whereby the second total power input that is less than said first total power input is obtained.

1. A method of operating a color display system (200,300,400) comprising at least a first color light emitter (202,402), a second color light emitter (204,404) and a third color light emitter (206,406), in which each light emitter is fed with an initial electric power input denoted P_{C1,0}, P_{C2,0} and P_{C3,0}, respectively, which add up to a first total electric power input P₀, whereby each light emitter provides an initial first color intensity, a second color intensity and a third color intensity, respectively, which, in combination, are perceivable to the human eye as an initial total brightness, the method being characterized in that power input is reduced to a second total power input P₁ by feeding each light emitter with a second electric power input denoted P_{C1,1}, P_{C2,1} and P_{C3,1}, respectively, whereby the second total power input P₁ that is less than said first total power input P₀ is obtained, and wherein the power ratios are P_{C3,1/}P_{C3,0<}P_{C2,0/}P_{C2,1} and P_{C1,1/}P_{C1,0<}P_{C2,0/}P_{C2,1.}

2. A method as claimed in claim 1, wherein, after the reduction of the power input, the combined intensities of the light emitters are perceivable to the human eye as a total brightness which is substantially the same as the initial total brightness prior to the reduction of the power input.

3. A method as claimed in claim 1, wherein power input to the second color light emitter is increased, so that it generates a second color intensity, which combines with the first color intensity and the third color intensity and is perceivable to the human eye substantially as said first total brightness.

4. A method as claimed in claim 3, wherein the power input to each first color light emitter and third color light emitter is substantially zero.

5. A method as claimed in claim 4, wherein the system also comprises at least a fourth color light emitter (304,408), with power being input to said fourth color light emitter, whereby the fourth color light emitter generates a fourth color intensity, which combines with the second color intensity and is perceivable to the human eye substantially as said first total brightness.

6. A method as claimed in to claim 1, wherein P_{C3,1}/P_{C3,0}<0.7*P_{C2,0}/P_{C2,1} and P_{C1,1}/P_{C1,0}<0.7*P_{C2,0}/P_{C2,1}.

7. A method as claimed in claim 1, wherein P_{C3,1}/P_{C3,0}<0.5*P_{C2,0}/P_{C2,1} and P_{C1,1}/P_{C1,0}<0.5*P_{C2,0}/P_{C2,1}.

8. A method as claimed in any one of claims 1 to 7, wherein said first, said second and said third color are red, green and blue, respectively.

9. A method as claimed in claim 5, wherein said fourth color is any one of the group comprising cyan, yellow and amber.

10. A color display system (200,300,400) comprising at least a first color light emitter (202,402), a second color light emitter (204,404) and a third color light emitter (206,406), and control circuitry (212,312,412) arranged to feed each light emitter with an initial electric power input denoted P_{C1,0}, P_{C2,0} and P_{C3,0}, respectively, which add up to a first total electric power input P₀, whereby each light emitter provides an initial first color intensity, a second color intensity and a third color intensity, respectively, which, in combination, are perceivable to the human eye as an initial total brightness, the system being characterized in that the control circuitry is arranged to reduce power input to a second total power input P₁ by feeding each light emitter with a second electric power input denoted P_{C1,1}, P_{C2,1} and P_{C3,1}, respectively, whereby the second total power input P₁ that is less than said first total power input P₀ is obtained, and wherein the power ratios are P_{C3,1}/P_{C3,0}<P_{C2,0}/P_{C2,1} and P_{C1,1}/P_{C1,0}<P_{C2,0}/P_{C2,1}.

11. A system as claimed in claim 10, wherein the control circuitry is arranged such that, after the reduction of the power input, the combined intensities of the light emitters are perceivable to the human eye as a total brightness which is substantially the same as the initial total brightness prior to the reduction of the power input.

12. A system as claimed in claim 10 or 11, wherein the control circuitry is arranged to increase the power input to the second color light emitter, so that it generates a second color intensity, which combines with the first color intensity and third color intensity and is perceivable to the human eye substantially as said first total brightness.

13. A system as claimed in claim 12, wherein the control circuitry is arranged to reduce the power input to each first color light emitter and third color light emitter to substantially zero.

14. A system as claimed in claim 13, wherein the system also comprises at least a fourth color light emitter (304,408) and the control circuitry is arranged to input power to said fourth color light emitter, whereby the fourth color light emitter generates a fourth color intensity, which combines with the second color intensity and is perceivable to the human eye substantially as said first total brightness.

15. A system as claimed in claim 10, wherein P_{C3,1}/P_{C3,0}<0.7*P_{C2,0}/P_{C2,1} and P_{C1,1}/P_{C1,0}<0.7*P_{C2,0}/P_{C2,1}.

16. A system as claimed in claim 10, wherein P_{C3,1}/P_{C3,0}<0.5*P_{C2,0}/P_{C2,1} and P_{C1,1}/P_{C1,0}<0.5*P_{C2,0}/P_{C2,1}.

17. A system as claimed in claim 10, wherein said first, said second and said third color are red, green and blue, respectively.

18. A system as claimed in any one of claims 14 to 17, wherein said fourth color is any one of the group comprising cyan, yellow and amber.

19. An electronic device comprising a color display system as claimed in claim 10.

20. A device as claimed in claim 19, wherein said device is battery-powered.

21. A device as claimed in claim 19 or 20 containing electronic circuitry which adjusts the power levels to the light emitters, depending on the image signal content.
